(19) United States
(12) Patent Application Publication
(10) Pub. No.: US 2008/0210726 A1
(43) Pub. Date: Sep. 4, 2008

(54) BEVERAGE HEATING AND COOLING DEVICE AND ASSOCIATED METHODS

(76) Inventor: Robert Lee Josephs, Palm Bay, FL (US)

Correspondence Address: Zies, Widerman, Sutch & Malek, P.L., 202 N. Harbor City Blvd, Suite #200, Melbourne, FL, 32935, US

(21) Appl. No.: 12/119,532

(22) Filed: May 13, 2008

Related U.S. Application Data
(63) Continuation-in-part of application No. 11/404,992, filed on Apr. 17, 2006, now abandoned.

(51) Int. Cl. B60R 7/06; B60R 11/00; B60N 3/10; F16M 13/02

(52) U.S. Cl. 224/483; 248/311.2

(57) ABSTRACT

A beverage heating and cooling device includes a vent connection member and a beverage containing member that is pivotally connected to the vent connection member. The vent connection member may include a base, a pair of opposing side members extending upwardly from the base, a cross member connected to and extending between the pair of opposing side members, and at least one clip member connected to the cross member and adapted to engage a vehicle vent. The beverage containing member may include a base, and a sidewall connected to and extending upwardly from the base. The sidewall may have a curved front, side members and an open back. The beverage heating and cooling device is adapted to receive a beverage container and position the beverage container adjacent a vehicle vent to heat or cool the beverage within the beverage container.

### RELATED APPLICATIONS

The present application is a continuation-in-part of U.S. patent application Ser. No. 11/404,992 filed on Apr. 17, 2006, titled “Beverage Cooler/Heater,” by the inventor of the current application, the entire contents of which are incorporated herein by reference.

### FIELD OF THE INVENTION

The present invention relates to the field of beverage holders and, more specifically, to beverage holders that allow a beverage to be heated or cooled in a beverage container while being held therein, and associated methods.

### BACKGROUND OF THE INVENTION

It is often necessary and convenient to heat or cool a beverage while in a vehicle. The ventilation system of a vehicle is typically a good source of hot or cool air. Accordingly, it is preferable to use the ventilation system of a vehicle to heat or cool a beverage.

Several devices exist to allow a user to position a beverage container adjacent a vehicle vent to utilize the warm or cool air from the vehicle ventilation system to heat or cool the beverage. For example, U.S. Pat. No. 6,560,983 to Schimmeyer discloses a holder to support a beverage container against a vehicle vent in an automobile. The device includes a clip member having arm portions that are adapted to engage vertical grill portions of a vent. More specifically, the arm members may be positioned between the vertically extending grill members. Further, the clip member includes an outwardly protruding interconnecting portion to connect to a beverage containing member. The beverage containing member slidably connects to the interconnecting member so that the beverage containing member may support a beverage container adjacent the vehicle vent. This device, however, does not account for vehicle vents that do not include vertically extending grill portions.

A more complicated device is disclosed in U.S. Pat. No. 5,165,646 to Gewecke. The auto dashboard drink container disclosed in the Gewecke '646 patent is a large attachment that connects to the dashboard of a vehicle over the vents. Accordingly, the vents are completely blocked and the air can only be used to heat or cool a beverage container.

U.S. Pat. No. 5,961,083 to Hartman, et al. discloses an attachment apparatus for attaching a beverage container to a ventilation system of a vehicle. The attachment apparatus includes a pair of vent clip members that clip to the grill portions of the vent.

### SUMMARY OF THE INVENTION

In view of the foregoing background, it is therefore an object of the present invention to provide a beverage heating and cooling device that may be readily connected to a ventilation system in a vehicle. It is also an object of the present invention to provide a beverage heating and cooling device that allows for the positioning of several different types of beverage containers adjacent a vent and a ventilation system of the vehicle.

These and other objects, features, and advantages in accordance with the present invention are provided by a beverage heating and cooling device including a vent connection member and a beverage containing member that is pivotally connected to the vent connection. The vent connection member preferably includes a base, a pair of opposing side members extending upwardly from the base, a cross member connected to and extending between the pair of opposing side members, and a clip member connected to the cross member and adapted to engage a vehicle vent. The beverage containing member preferably includes a base and a sidewall connected to and extending upwardly from the base. The sidewall may have a curved front, side members and an open back.

The upper portion of each one of the pair of opposing side members on the vent connection member may include a plurality of passageways formed therein. Further, each of the side members of the sidewall of the beverage containing device may include a passageway formed therein. The beverage heating and cooling device may also include a position retaining member that is adapted to engage the passageways formed in the side members of the beverage containing device and in the side members of the vent connection member. The position retaining member advantageously allows for the beverage containing member to be pivotally moved and fixed in relation to the vent connection member.

The curved front of the sidewall of the beverage containing member may include a U-shaped passageway formed therein. The U-shaped passageway advantageously allows for any type of beverage container having a handle to be positioned within the sidewalls of the beverage containing member.

The beverage containing device and the vent connection device may each be integrally molded as a monolithic unit. Further, the vent connection member and the beverage containing member may be made of wood material, plastic material, or composite material, for example. The vent connection member may include more than one clip member. Additional clip members advantageously enhance stability of the beverage heating and cooling device when connected to the vent of a vehicle.

A method aspect of the present invention is for using a beverage heating and cooling device. The method may include connecting the vent connection member having the beverage containing member pivotally connected thereto to the vent of a vehicle by engaging the clip member with a portion of the vent. The method may also include positioning a beverage container between the sidewalls of the beverage containing device so that air from the vent of the vehicle travels past the vent connection member and around the beverage container within the sidewalls of the beverage containing member to adjust the temperature of a beverage being carried by the beverage container.

### BRIEF DESCRIPTION OF THE DRAWINGS

FIG. 1 is a partial environmental view of a beverage heating and cooling device according to the present invention.

FIG. 2a is a partial environmental view of the beverage heating and cooling device illustrated in FIG. 1 and showing a beverage container being carried by the beverage containing member.

FIG. 2b is a partial environmental view of the beverage heating and cooling device illustrated in FIG. 1 and showing another type of beverage container being carried by the beverage containing member.

FIG. 3 is an exploded perspective view of a beverage heating and cooling device including a vent connection member having integrally formed clip members according to the present invention.

FIG. 4 is a perspective view of the beverage heating and cooling device illustrated in FIG. 1 and showing various pivotal positions of the beverage containing member relative to the vent connection member.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

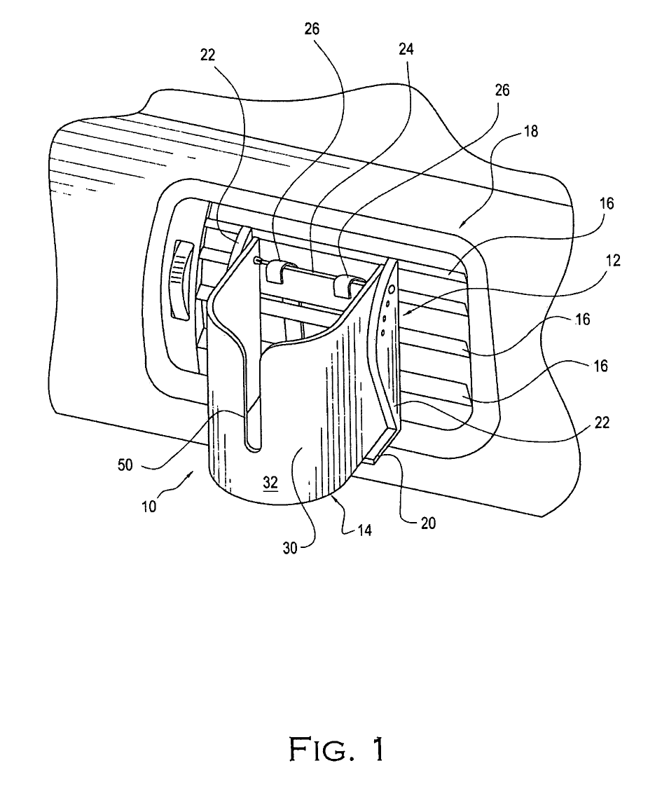

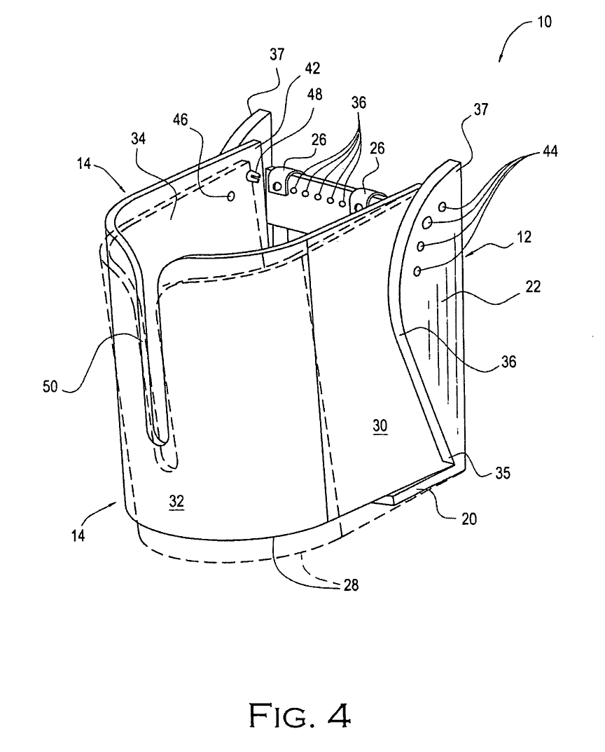

Referring now initially to FIG. 1, a beverage heating and cooling device 10 according to the present invention is now described in greater detail. The beverage heating and cooling device 10 illustratively includes a vent connection member 12 and a beverage containing member 14 pivotally connected to the vent connection member. More particularly, and as perhaps best illustrated in FIGS. 1 and 4, the vent connection member 12 is adapted to be connected to horizontally extending grill portions 16 of a vehicle vent 18.

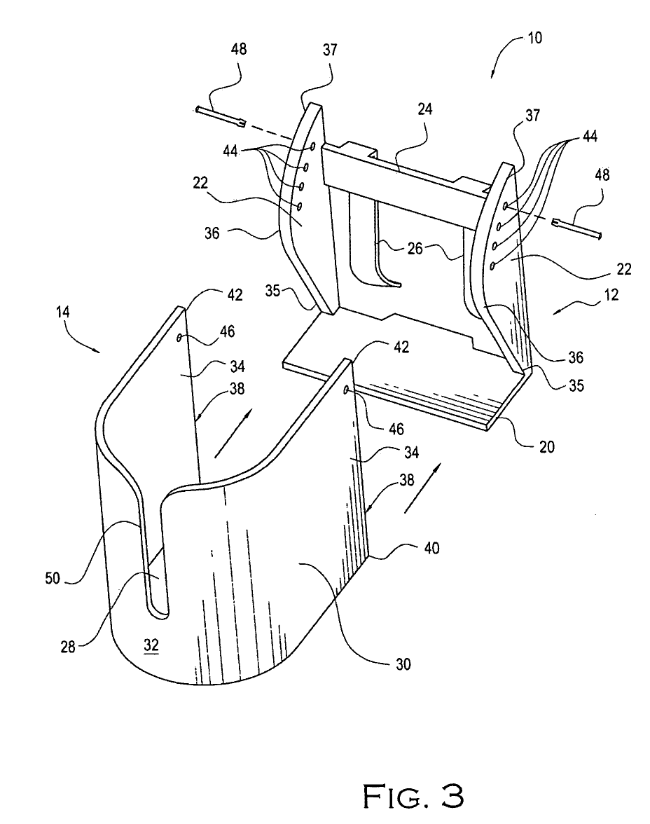

As perhaps best illustrated in FIG. 3, the vent connection member 12 includes a base 20, a pair of opposing side members 22, a cross member 24 connected to and extending between the pair of opposing side members, and a clip member 26 connected to the cross member and adapted to engage the vehicle vent 18. As illustrated, for example, in FIG. 3, the clip member 26 may be integrally formed with the cross member 24. As illustrated, however, in FIG. 4, the clip member 26 may alternately be separate from the cross member 24 and may detachably connect to the cross member. The beverage heating and cooling device 10 illustrated in the figures shows a pair of clip members 26. Those skilled in the art, however, will appreciate that any number of clip members 26 may be included to accomplish the features and advantages of the present invention.

The beverage containing member 14 illustratively includes a base 28 and a sidewall 30 connected to and extending upwardly from the base. The sidewall 30 may include a curved front 32, side members 34 and an open back. Those skilled in the art will appreciate that although the beverage containing member 14 is illustrated as having a curved front 32, the beverage containing member may have any other shape suitable for carrying a beverage container. For example, the beverage containing member 14 may have a square shape and still accomplish the goals and features of the present invention. The beverage containing member 14 is adapted to engage the vent connection member 12.

More specifically, the base 28 of the beverage containing member 14 may overlie the base 20 of the vent connection member 12 when the beverage containing member is positioned to engage the vent connection member. Accordingly, the beverage containing member 14 may pivotally engage the vent connection member 12.

Each of the pair of opposing side members 22 of the vent connection member 12 may have an arcuate shape. More specifically, each of the pair of opposing side members 22 may have a base 35, a medial portion 36, and an upper portion 37. The base portion 35 of each of the opposing side members 22 may have a substantially narrower depth than the medial portion 36 of each of the opposing side members. Further, the upper portion 37 of each of the opposing side members 22 may have a substantially narrower depth than the medial portion 36 of the opposing side members. Accordingly, each of the opposing side members 22 of the vent connection member 12 may have a substantially arcuate shape wherein the medial portion 36 of the opposing side members is thicker than the base portion 35 and the upper portion 37 of the opposing side members.

The open back of the beverage containing member 14 may be defined by end wall portions 38 of the side members 34 of the beverage containing member 14. The end wall portions 38 of the side members 34 of the beverage containing member 14 may have lower portions 40 adjacent the base 28 of the beverage containing member and upper portions 42 opposite the lower portions. The open back of the beverage containing member 14 may also advantageously allow for air to flow freely from the vehicle vent 18 through the beverage containing member 14 when the beverage container is being held therein.

Referring now additionally to FIGS. 3 and 4, the connection between the beverage containing member 14 and the vent connection member 12 is now described in greater detail. More specifically, the upper portions 37 of the pair of opposing side members 22 of the vent connection member 12 each include a plurality of passageways 44 formed there through. A first one of the plurality of passageways 44 may illustratively be positioned adjacent a medial portion 36 of the opposing side members 22, and extend upwardly towards the upper portion 37 of each of the opposing side members 22. The upper portion 42 of the end walls 38 of the beverage containing member 14 may also include a passageway 46 formed therethrough. The beverage containing member 14 illustrated in FIGS. 3 and 4 include a single passageway 46 formed in each of the end wall portions 38. Those skilled in the art, however, will appreciate that any number of passageways 46 may be included to accomplish the goals and features of the present invention.

The beverage heating and cooling device 10 may also include a position retaining member 48. The position retaining member 48 is preferably adapted to engage the passageways 44 in the vent connection member 12 in the passageways 46 in the beverage containing member 14. More specifically, the beverage containing device 10 may include a pair of position retaining members 48. Each one of the pair of position retaining members 48 is preferably passed through one of the passageways 46 in the beverage containing member 14 and one of the plurality of passageways 44 in the vent connection member 12. The position retaining members 48 may be provided by a pin, for example, or any other structure suitable for positioning through the passageway 44 in the vent connection member 12 and the passageway 46 in the beverage containing member 14.

As perhaps best illustrated in FIG. 4, the beverage containing member 14 may be pivotally moved relative to the vent connection member 12. When in the desired position, the position retaining members 48 may be used to fix the position of the beverage containing member 14 relative to the vent connection member 12 by engaging the passageways 44 in the vent connection member and the passageways 46 in the beverage containing member.

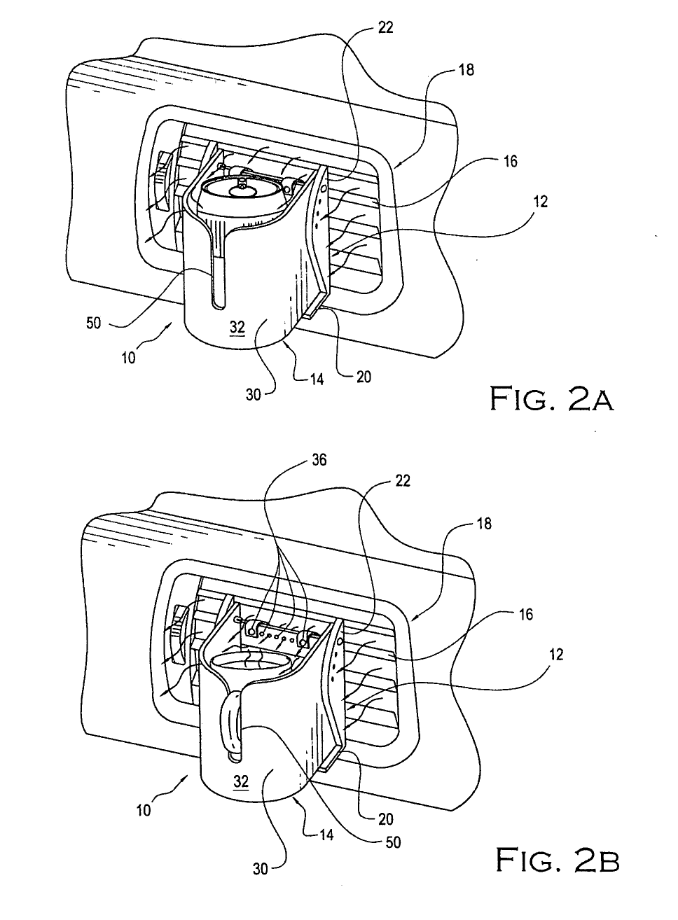

As perhaps best illustrated in FIGS. 2a and 2b, the beverage heating and cooling device 10 may be used to heat or cool any type of beverage contained in any type of beverage container. A U-shaped passageway 50 may be included in the curved front 32 of the sidewall 30 of the beverage containing member 14. The U-shaped passageway 50 advantageously allows a beverage container having a handle, e.g., a coffee mug or travel cup, to be used with the beverage heating and cooling device 10.

The open back of the beverage containing member 14 advantageously allows for air flowing from the vehicle vent 18 to pass through the beverage containing member. Further, the curved front 32 advantageously allows the air flowing from the vehicle vent 18 to surround the beverage container when positioned within the beverage containing member 14. The U-shaped passageway 50 also advantageously allows the air flowing within the beverage containing member to escape so as to allow a continuous flow of warm or cool air to surround the beverage container when positioned within the beverage containing member 14.

The cross member 24 of the vent connection member 12 advantageously enhances strength and stability of the vent connection member 12. Those skilled in the art, however, will appreciate that the vent connection member 12 may be formed without use of the cross member 24.

As perhaps best illustrated in FIG. 3, the vent connection member 12 may be integrally formed as a monolithic unit. Further, the beverage containing member 14 may also be integrally formed as a monolithic unit. This advantageously enhances manufacturing of the vent connection member 12 and the beverage containing member.

The vent connection member 12 and the beverage containing member 14 may be made of wood material, plastic material, or a composite material. Those skilled in the art will appreciate that the vent connection member 12 and the beverage containing member 14 are preferably made of a material that does not conduct a great deal of heat. Those skilled in the art will also appreciate that it is preferred that the vent connection member 12 and the beverage containing member 14 are made of a material that does not readily deform when exposed to hot and cold temperatures. This advantageously enhances use of the beverage heating and cooling device 10 by insuring that the temperature of the beverage heating and cooling device does not become uncomfortable to the touch of the user when in use.

A method aspect of the current invention is for using the beverage heating and cooling device 10. The method includes connecting the vent connection member 12 having the beverage containing member 14 pivotally connected thereto to the vehicle vent 18 by engaging the clip member 25 with a grill portion 16 of the vehicle vent. The method also includes positioning a beverage container between the sidewalls 30 of the beverage containing member 14 so that air from the vehicle vent 18 travels past the vent connection member 12 and around the beverage container within the sidewalls 30 of the beverage containing member to adjust the temperature of the beverage being carried by the beverage container. The method may also include pivoting the beverage containing member 14 relative to the vent connection member 12 and fixing the beverage containing member in a predetermined position by engaging the position retaining member 18 with the passageways 44 formed in the vent connection member 12 and the passageways 46 formed in the beverage containing member 14.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A beverage heating and cooling device comprising:
a vent connection member comprising
a base,
a pair of opposing side members extending upwardly from the base,
a cross member connected to and extending between the pair of opposing side members, and
at least one clip member connected to the cross member and adapted to engage a vehicle vent; and
a beverage containing member pivotally connected to said vent connection member and comprising
a base, and
a sidewall connected to and extending upwardly from the base, the sidewall having a curved front, side members and an open back.

2. A beverage heating and cooling device according to claim 1 wherein an upper portion of each one of the pair of opposing side members on said vent connection member include a plurality of passageways formed therein.

3. A beverage heating and cooling device according to claim 2 wherein each of the side members of the sidewall of said beverage containing device includes at least one passageway formed therein;

4. A beverage heating and cooling device according to claim 3 further comprising a position retaining member adapted to engage the passageways formed in the side members of the sidewall of said beverage containing device and the passageways formed in the upper portion of each of the pair of opposing side members on said vent connection member to fix a position of the said beverage containing member relative to said vent connection member.

5. A beverage heating and cooling device according to claim 1 wherein the curved front of the sidewall of said beverage containing member includes a U-shaped passageway formed therein.

6. A beverage heating and cooling device according to claim 1 wherein said beverage containing device and said vent connection device are each integrally molded as a monolithic unit.

7. A beverage heating and cooling device according to claim 1 wherein said vent connection member and said beverage containing member are made of at least one of wood material, plastic material, or a composite material.

8. A beverage heating and cooling device according to claim 1 wherein the at least one clip member comprises a pair of clip members.

9. A beverage heating and cooling device comprising:
a vent connection member comprising
a base,
a pair of opposing side members extending upwardly from the base, each one of the pair of opposing side members including a plurality of passageways formed therein,
a cross member connected to and extending between the pair of opposing side members, and
a pair of clip members connected to the cross member and adapted to engage a vehicle vent; and
a beverage containing member pivotally connected to said vent connection member and comprising
a base,
a sidewall connected to and extending upwardly from the base, the sidewall having at least one passageway formed therein for engaging at least one of the plurality of passageways formed in the pair of opposing side members.

10. A beverage heating and cooling device according to claim 9 further comprising a position retaining member adapted to engage the least one passageway formed in the sidewall of said beverage containing device and the passageways formed in the upper portion of each of the pair of opposing side members on said vent connection member to fix a position of the said base containing member relative to said vent connection member.

11. A beverage heating and cooling device according to claim 9 wherein the sidewall of said beverage containing member includes a U-shaped passageway formed therein.

12. A beverage heating and cooling device according to claim 9 wherein said beverage containing device and said vent connection device are each integrally molded as a monolithic unit.

13. A beverage heating and cooling device according to claim 9 wherein said vent connection member and said beverage containing member are made of at least one of wood material, plastic material, or a composite material.

14. A method of using a beverage heating and cooling device including a vent connection member and a beverage containing member pivotally connected to the vent connection member, the vent connection member including a base, a pair of opposing side members extending upwardly from the base, a cross member connected to and extending between the pair of opposing side members and at least one clip member connected to the cross member, the beverage containing member including a base, and a sidewall connected to and extending upwardly from the base, the method comprising:
connecting the vent connection member having the beverage containing member pivotally connected thereto to a vent of a vehicle by engaging the at least one clip member with a portion of the vent; and
positioning a beverage container between the sidewalls of the beverage containing device so that air from the vent of the vehicle travels past the vent connection member and around the beverage container within the sidewalls of the beverage containing member to adjust the temperature of a beverage being carried by the beverage container.

15. A method according to claim 14 wherein an upper portion of each one of the pair of opposing side members on the vent connection member include a plurality of passageways formed therein; and wherein each of the side members of the sidewall of the beverage containing device includes at least one passageway formed therein.

16. A method according to claim 15 further comprising pivoting the beverage containing member relative to the vent connection member and fixing the beverage containing member in a predetermined position by engaging a position retaining member with the passageways formed in the side members of the sidewall of the beverage containing device and the passageways formed in the upper portion of each of the pair of opposing side members on the vent connection member.

17. A method according to claim 14 wherein the curved front of the sidewall of the beverage containing member includes a U-shaped passageway formed therein; and wherein positioning the beverage container between the sidewalls of the beverage containing member further comprises extending a handle of the beverage container through the U-shaped passageway.

18. A method according to claim 14 wherein the beverage containing device and the vent connection device are each integrally molded as a monolithic unit.

19. A method according to claim 14 wherein the vent connection member and the beverage containing member are made of at least one of wood material, plastic material, or a composite material.

20. A method according to claim 14 wherein the at least one clip member comprises a pair of clip members.
